(19) United States
(12) Patent Application Publication
(10) Pub. No.: US 2026/0051186 A1
(43) Pub. Date: Feb. 19, 2026

(54) METHODS AND SYSTEMS FOR MULTI-MODEL DEEP FAKE DETECTION OF AN ANOMALY IN AN AUDIO-VIDEO DATA STREAM

(71) Applicant: Booz Allen Hamilton Inc., McLean, VA (US)

(72) Inventors: Catherine Ordun, Fairfax, VA (US); Ryan Swope, Philadelphia, PA (US); Jonathan Gaminde, Summerville, SC (US); Sean Anthony Guillory, Schertz, TX (US); Toan Le, Silver Spring, MD (US); Tyler Nivin, St Louis, MO (US)

(73) Assignee: Booz Allen Hamilton Inc., McLean, VA (US)

(21) Appl. No.: 19/260,758

(22) Filed: Jul. 7, 2025

Related U.S. Application Data
(60) Provisional application No. 63/682,675, filed on Aug. 13, 2024.

(51) Int. Cl. G06V 20/00; G06T 7/73; G06T 7/90; G06V 10/62; G06V 10/764; G06V 20/40

(52) U.S. Cl. CPC G06V 20/95; G06T 7/74; G06T 7/90; G06V 10/62; G06V 10/764; G06V 20/46; G06T 2207/10016; G06T 2207/20056; G06T 2207/20081; G06T 2207/30196

(57) ABSTRACT

Embodiments can relate to a system for detecting an anomaly, the system including a processing module. The processing module can extract an audio feature and a video feature. The processing module can generate an audio vector and a video vector. The processing module can amplify amplitude differences of spatial and temporal values between at least two video frames and/or phase differences of spatial and temporal values between at least two video frames. The processing module can perform a threshold comparison by determining whether an amplified amplitude difference is greater than a threshold amplitude difference and/or whether an amplified phase difference that is greater than a threshold phase difference. The processing module can determine change-in-position of an object associated with the extracted audio feature and corresponding video feature as a change-in-position anomaly or a change-in-position normality, and classify the data input as including a data manipulation or a no-data manipulation.

### CROSS-REFERENCE TO RELATED APPLICATIONS

This patent application is related to and claims the benefit of priority of U.S. provisional patent application No. 63/682,675, filed on Aug. 13, 2024, the entire contents of which is incorporated herein by reference.

### FIELD

Embodiments can relate to systems and methods for multi-model detection of an anomaly in an audio-video data stream containing audio content and video content.

### BACKGROUND INFORMATION

Mis/Disinformation is a prevalent issue within information environments. For instance, use of manipulated and fabricated content generated by artificial intelligence (AI) to generate deep fakes is increasing in use over time. The World Economic Forum's Global Risks Report 2024 ranks misinformation and disinformation as the number one global short-term threat the world faces in the next two years. The volume of AI-generated disinformation has been rising by an average of 130% per month on X over the last year according to the Center for Countering Digital Hate (CCDH). Primary issues range from fabricated news stories, impersonated political figures, and content that could lead to fraudulent financial authorizations and stock market manipulation. Current problems in the deep fakes space include difficulty in producing automated methods of deep fake detection especially around content with multiple modalities (e.g., auditory, visual, etc.).

Multiple-model approaches exist to detect AI generation and manipulation in audio, video, images, and text, but they focus on one mode of deep fakes at a time. In addition, to-date no deep fakes model incorporates a physiologically informed approach for detection.

Motion magnification provides promise in deep fake detection, as evidenced by https://ordun.ghost.io/2024/01/03/taking-a-look-at-how-do-deep fakes-move/. For instance, real videos (pristine) will follow human facial muscular patterns classified in the affective computing literature as Facial Action Units (FAU). These movements from frame-to-frame can be represented as motion magnification vectors. Motion magnification vectors are stable for pristine videos but fragile for deep fakes, which provides an opportunity to for deep fake detection via magnification. However, generative models (e.g., GAN) used for deep fake detection tend to amplify synthetic noise, thereby eliminating motion magnification during the magnification process. This can be attributed to the generative model's training. For instance, a generative model will overpower subtle information related to how muscles move because these movements contribute relatively little information compared to the overall video—if these movements contribute little information then they will not be prioritized during training of the generative model. As a result, the generated noise is amplified and not the muscular motion. Thus, while motion magnification provides promise in the area of deep fake detection, current models and techniques negate this.

Another problem plaguing known deep fake detection techniques is the inability to determine which modality(ies) (e.g., the audio, the video, etc.) of the content has been manipulated. Rather, known deep fake techniques operate as binary classifiers, in that they generate one of two results-the content is fake or the content is real.

Known techniques for detecting deep fakes can be appreciated from:
1. CN 117238015 Wang et al.;
2. KR 20240054681 Baek et al.;
3. U.S. Pat. No. 20,220,269922 Mathews;
4. Das, R., Negi, G., & Smeaton, A. F. (2021). Detecting Deep fake Videos Using Euler Video Magnification. arXiv preprint arXiv: 2101.11563; Kolagati, S., Priyadharshini, T., & Rajam, V. M. A. (2022). Exposing Deep fakes Using A Deep Multilayer Perceptron-Convolutional Neural Network Model. International Journal of Information Management Data Insights, 2(1), 100054;
5. RUB-SysSec. (2021). Rub-SysSec/Wavefake. Retrieved from https://github.com/RUB-SysSec/WaveFake.;
6. Wodajo, D., Atnafu, S., & Akhtar, Z. (2023). Deep fake Video Detection Using Generative Convolutional Vision Transformer. arXiv preprint arXiv: 2307.07036.

### SUMMARY

An exemplary embodiment can relate to a system for detecting an anomaly in an audio-video data stream or an audio-video data file. The system can include an input module configured to receive data input. The data input can include an audio-video data stream or an audio-video data file. The system can include a processing module. The system can include a memory. The memory can have instructions thereon that, when executed by the processing module, will cause the processing module to perform one or more of the functions disclosed herein. The instructions can cause the processing module to extract an audio feature and a corresponding video feature within a frequency band. The frequency band can be a frequency band spanning a spatial and temporal range between at least two video frames of the data input. The extraction can be based on a machine learning technique that extracts features based on patterns. The instructions can cause the processing module to generate an audio vector associated with the extracted audio feature. The instructions can cause the processing module to generate a video vector associated with the extracted video feature. The instructions can cause the processing module to amplify, via a non-Lagrangian technique, amplitude differences of spatial and temporal values between the at least two video frames. In addition, or in the alternative, the instructions can cause the processing module to amplify, via a non-Lagrangian technique, phase differences of spatial and temporal values between the at least two video frames. The instructions can cause the processing module to perform a threshold comparison by determining whether an amplified amplitude difference is greater than a threshold amplitude difference and/or whether an amplified phase difference that is greater than a threshold phase difference. The instructions can cause the processing module to determine, based on the threshold comparison, change-in-position of an object associated with the extracted audio feature and corresponding video feature as a change-in-position anomaly or a change-in-position normality. The instructions can cause the processing module to classify the data input as including a data manipulation or a no-data manipulation based on the change-in-position anomaly or the change-in-position normality. The instructions can cause the processing module to generate an output representative of the classification.

An exemplary embodiment can relate to a method for detecting an anomaly in an audio-video data stream or an audio-video data file. The method can involve receiving data input. The data input can include an audio-video data stream or an audio-video data file. The method can involve extracting an audio feature and a corresponding video feature within a frequency band. The frequency band can be a frequency band spanning a spatial and temporal range between at least two video frames of the data input. The extraction can be based on a machine learning technique that extracts features based on patterns. The method can involve generating an audio vector associated with the extracted audio feature. The method can involve generating a video vector associated with the extracted video feature. The method can involve amplifying via a non-Lagrangian technique, amplitude differences of spatial and temporal values between the at least two video frames. In addition, or in the alternative, the method can involve amplifying via a non-Lagrangian technique, phase differences of spatial and temporal values between the at least two video frames. The method can involve performing a threshold comparison by determining whether an amplified amplitude difference is greater than a threshold amplitude difference and/or whether an amplified phase difference that is greater than a threshold phase difference. The method can involve determining, based on the threshold comparison, change-in-position of an object associated with the extracted audio feature and corresponding video feature as a change-in-position anomaly or a change-in-position normality. The method can involve classifying the data input as including a data manipulation or a no-data manipulation based on the change-in-position anomaly or the change-in-position normality. The method can involve generating an output representative of the classification.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1A shows an exemplary block diagram of an embodiment of a system for detecting an anomaly in an audio-video data stream or an audio-video data file;

FIG. 1B shows an exemplary implementation of an embodiment of techniques related to detecting an anomaly in an audio-video data stream or an audio-video data file;

FIG. 2 shows an optical flow (e.g., Lagrangian) technique that predicts a motion vector for every pixel across consecutive frames of a video;

FIG. 3 shows an Eulerian Video Magnification (e.g., non-Lagrangian) technique that uses spatial (pixel) and temporal processing to amplify variation given a frequency band of interest;

FIG. 4 shows graphical illustrations of motion amplification on a ID signal for different spatial frequencies and a values, wherein the intensity plots of panel (a) show true motion amplification and intensity plots of panel (b) show motion amplification via temporal filtering;

FIG. 5 shows a deep fake video;

FIG. 6 shows an image of a crane imperceptibly swaying in the wind, along with magnification techniques applied to the image;

FIG. 7 shows a 1D signal being deconstructed into amplitude and phase, and also shows a 2D Discrete Fourier Transform similarly decomposed into amplitude and phase;

FIG. 8 shows an example of retrieving phase data from data processed by a phase-based magnification technique;

FIGS. 9A-9B show exemplary flow diagrams pertaining to an embodiment of a system for detecting an anomaly in an audio-video data stream or an audio-video data file;

FIG. 10 illustrates known real and fake videos from several generators;

FIG. 11 shows an exemplary architecture for implementing an embodiment of the system and method; and

FIGS. 12A, 12B, and 12C illustrate examples of detecting deep fake images using different magnification parameters.

### DETAILED DESCRIPTION

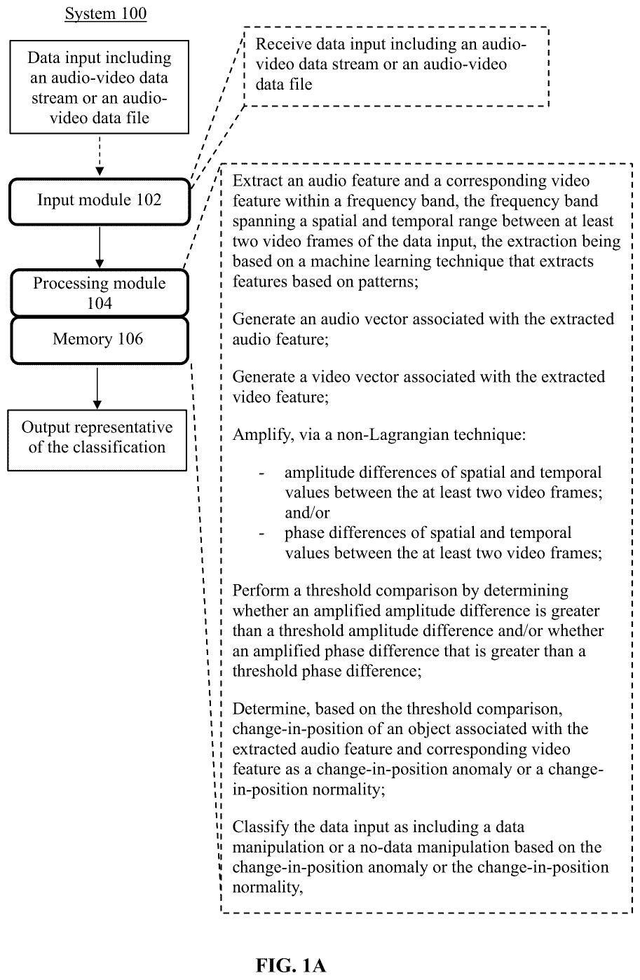

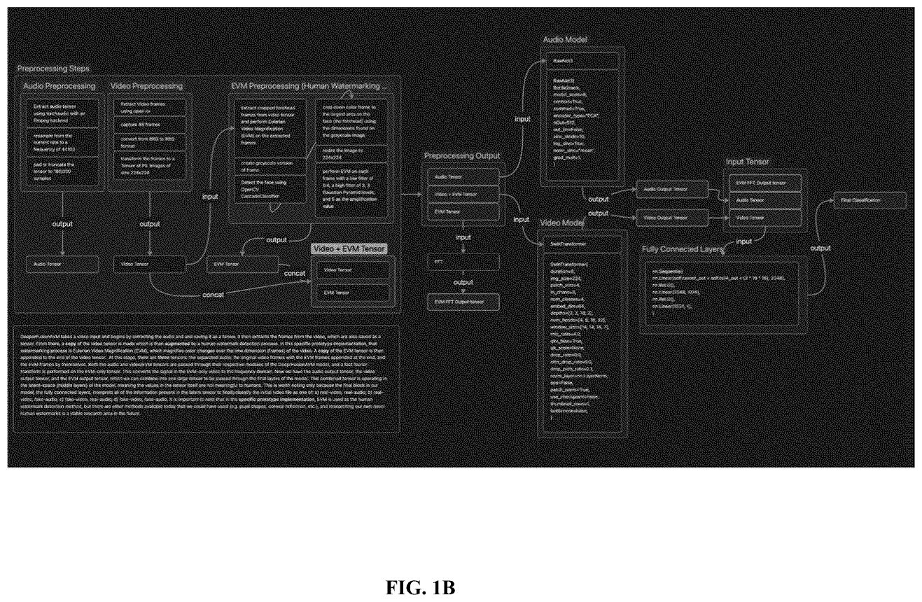

Referring to FIGS. 1A-1B, embodiments can relate to a system 100 for detecting an anomaly in an audio-video data stream or an audio-video data file. The system 100 can include a processor. The processor can include one or more of the operating modules (e.g., input module 102, processing module 104, etc.) disclosed herein, or any of the operating modules can include one or more of the processors. Any of the processors can include or be operatively associated with a memory. The memory can store instructions thereon which can be executed by the processor to perform any of the functions disclosed herein. The instructions can be in the form of computer logic, algorithms, models, etc. and stored as a computer program, a data structure, etc. While exemplary embodiments may describe and/or illustrate one processor and one memory, it is understood that the system 100 can include any number of processors and memories.

The processor can be any of the processors disclosed herein. The processor can be part of or in communication with a machine (logic, one or more components, circuits (e.g., modules), or mechanisms). The processor can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. Use of processors herein can include any one or combination of a Graphics Processing Unit (GPU), a Field Programmable Gate Array (FPGA), a Central Processing Unit (CPU), etc. The processor can include one or more operating modules. An operating module can be a software or firmware operating module configured to implement any of the method steps disclosed herein. The operating module can be embodied as software and stored in memory, the memory being operatively associated with the processor. An operating module can be embodied as a web application, a desktop application, a console application, etc.

The processor can include or be associated with a computer or machine readable medium. The computer or machine readable medium can include memory. The computer or machine readable medium can be configured to store one or more instructions thereon. The instructions can be in the form of algorithms, program logic, a model, etc. that cause the processor to perform any of the functions described herein.

Any of the memory discussed herein can be computer readable memory configured to store data. The memory can include a volatile or non-volatile, transitory or non-transitory memory, and be embodied as an in-memory, an active memory, a cloud memory, etc. Embodiments of the memory can include an operating module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The processor can be in communication with other processors of other devices (e.g., a computer device, a desktop computer, a laptop computer, a computer system, etc.). Any of those other devices can include any of the exemplary processors disclosed herein. Any of the processors can have transceivers or other communication devices/circuitry to facilitate transmission and reception of wireless signals. Any of the processors can include an Application Programming Interface (API) as a software intermediary that allows two applications to talk to each other. Use of an API can allow software of the processor of the system to communicate with software of the processor of the other device(s), if the processor of the system is not the same processor of the device.

Any data transmission between the processor and memory, between the processor and a database, and between the processor and processors of other devices, between the processor of one operating module and a processor of another operating module, etc. can be via a pull operation (e.g., the processor can pull the data) or a push operation (e.g., the data can be pushed to the processor). The processor can receive and process the data in steaming format, or store it in memory before being processed.

As noted herein, the processor can be configured to be a component of, used in combination with, or in communication with another device/system—e.g., this can include the processor being part of the device/system, the device/system being part of the processor, the processor in communication with the device/system, etc. “Being part of” can include being on a same substrate or integrated circuit. For instance, the processor can be a component of, used in combination with, or in communication with a predictive modeling system, a decision support system, an automated control system, etc. The processor can use the techniques disclosed herein to assist with or augment the performance of these devices/systems.

The system 100 can include an input module 102. The input module 102 can be configured to receive data input. The data input can be an audio-video data stream and/or an audio-video data file. The input module 102 can be a media receiver configured to receive analog (e.g., a continuous-time signal) or digital (e.g., encoded machine-readable data) information representative of the data stream format or data file format of the data input. For instance, the input module 102 can be a media receiver configured to receive analog or digital information representative of an audio-video data stream or an audio-video data file. The input module 102 can also be configured to process and/or store the input data. For instance, the input module 102 can have a processor and memory to facilitate processing (e.g., modulation, demodulation, filtering, pre-processing, encoding, etc.) and storage of the raw input data or the processed input data. The input module 102 can also include circuitry, processing blocks, analog to digital converters, digital to analog converters, etc. to facilitate analog processing, digital processing, filtering, amplification, etc.

The system 100 can include a processing module 104. The processing module 104 can be in communication with the input module 102. The processing module 104 can have a processor and a memory. The system 100 can include a memory 106. Each of the system 100, the input module 102, and the processing module 104 can share the same memory, have their own individual memory, or some combination thereof. The memory 106 can have instructions thereon that, when executed by the processing module 104, can cause the processing module 104 to perform one or more of the functions disclosed herein.

The processing module 104 can receive (e.g., push operation) or retrieve (e.g., pull operation) the input data from the input module 102 or from a data store where the input module 102 stored the data input. The processing module 104 can be configured to receive/retrieve the input data and perform operations on the input data in real-time, in a batch processing process, on-demand as required by a user of the system 100, in accordance with an algorithm (e.g., a predictive analytics algorithm, a machine learning algorithm, etc.), or by some other scheme.

The instructions can cause the processing module 104 to extract an audio feature and a corresponding video feature. Extracting a corresponding video feature means that the video is associated with the audio in time. For instance, the audio-video data stream or an audio-video data file will have an audio component and a video component. The input data can have or be encoded with metadata to assign a timestamp to each component. The video component having the same or overlapping timestamp as that of the audio component can be a corresponding video component of the audio component. The audio feature and corresponding video feature can be extracted from a frequency band of the input data—e.g., the processing module can extract an audio feature and a corresponding video feature within a frequency band of the input data.

It is contemplated for the frequency band to span a spatial (e.g., pixel) and temporal range between at least two video frames of the data input. For instance, the extracted audio and corresponding video features can relate to a pixel of an object (e.g., an eyelid of a person within the input data) appearing in a first video frame and a pixel of the object appearing in a second video frame. Thus, the spatial span is achieved by the two related pixels and the temporal span is achieved by the two video frames. It is contemplated for the two video frames to be consecutive video frames, but they need not be. In addition, while exemplary embodiments discuss the span as being between two video frames and two pixels, it is understood that more than two video frames can be used and more than two pixels can be used.

The extraction of the audio feature and corresponding video feature can be via a machine learning technique that extracts features based on patterns. For instance, and as a non-limiting example, a convolutional neural network (CNN) can be used to transform data of the data input into numerical features that are compatible with the CNN machine learning algorithm, wherein these numerical features are representative of audio or video features. The transformation into numerical features can be done such that they represent the most discriminating characteristics of the audio or video components of interest, thereby extracting an audio feature and a corresponding video feature from the data input.

The instructions can cause the processing module 104 to generate an audio vector associated with the extracted audio feature. The instructions can also cause the processing module 104 to generate a video vector associated with the extracted video feature. Standard methods for generating vectors associated with extracted features can be used.

The instructions can cause the processing module 104 to amplify amplitude differences of spatial and temporal values between at least two video frames. In addition, or in the alternative, the instructions can cause the processing module 104 to amplify phase differences of spatial and temporal values between at least two video frames. It is contemplated for the amplification to be performed via a non-Lagrangian technique (e.g., Eulerian magnification technique). An amplitude difference of spatial and temporal values between at least two video frames can include determining a difference of intensities of two pixels corresponding with each other over a period of time. Determining a difference of intensities of two pixels corresponding with each other over a period of time can include determining a variation of an intensity of a pixel in a first video frame with an intensity of a corresponding pixel in a second video frame. Similarly, a phase difference of spatial and temporal values between at least two video frames can include determining a difference of phase of two pixels corresponding with each other over a period of time. Determining a difference of phase of two pixels corresponding with each other over a period of time can include determining a variation of phase of a Fourier Transform of an intensity signal of a pixel in a first video frame with a Fourier Transform of an intensity signal of a corresponding pixel in a second video frame. As a non-limiting example, determining a variation of phase can include determining a degree with which the Fourier Transforms of intensity signals are in-phase or out-of-phase.

The instructions can cause the processing module 104 to perform a threshold comparison by determining whether an amplified amplitude difference is greater than a threshold amplitude difference. In addition, or in the alternative, the instructions can cause the processing module 104 to determine whether an amplified phase difference is greater than a threshold phase difference. As noted herein, the amplification can be performed via a non-Lagrangian technique, as Lagranian techniques may not provide an effective means for motion magnification for purposes of detecting deep fakes. Thus, as a non-limiting example, the threshold values for comparison can be amplitude/phase difference values determine Lagrangian amplification. In this regard, the threshold amplitude difference can be based on an expected amplitude difference associated with Lagrangian amplification of the spatial and temporal values, and the threshold phase difference can be based on an expected phase difference associated with Lagrangian amplification of the spatial and temporal values.

The instructions can cause the processing module 104 to determine, based on the threshold comparison, change-in-position of an object (e.g., an eyelid of a person within the input data) associated with the extracted audio feature and corresponding video feature as a change-in-position anomaly or a change-in-position normality. For instance, as explained herein, motion magnification vectors are stable for pristine videos but fragile for deep fakes, and thus a magnification of motion can reveal whether the change in position is an anomaly or a normality. If the magnification of motion reveals that the amplified amplitude difference is greater than a threshold amplitude difference and/or that amplified phase difference that is greater than a threshold phase difference, then it can be determined that the motion is a change-in-position anomaly. If the magnification of motion reveals that the amplified amplitude difference is less than a threshold amplitude difference and/or that amplified phase difference that is less than a threshold phase difference, then it can be determined that the motion is a change-in-position normality.

The change-in-position of object can be object placement or position in a first video frame relative to the object's placement or position in a second video frame. An example of this can be eye saccade movement. The change-in-position of object can be distance between two objects in a first video frame relative to distance between the two objects in a second frame. An example of this can be difference in eye separation, difference in eye gaze, etc. The change-in-position of object can be based on differences in human physiological watermarks (e.g., heart rate, blood flow, etc.) captured via one or more computer vision techniques. Regarding the human physiological watermarks, a computer vision technique (e.g., Eulerian magnification technique) can magnify color changes of human skin over plural video frames. The processing module 104 can augment the extracted audio feature(s) and the extracted video feature(s) with these magnified color changes of human skin. The amplitude/phase differences associated with the human physiological watermark data within the augmented features can be used in addition to or in the alternative of the other object evaluations.

The instructions can cause the processing module 104 to classify the data input as including a data manipulation or a no-data manipulation based on the change-in-position anomaly or the change-in-position normality. The classification can include classifying the data input as having:
a. one or more data manipulations within the audio component or one or more no-data manipulations within the audio component;
b. one or more data manipulations within the video component or one or more no-data manipulations within the video component; and/or
c. one or more data manipulations within the audio component and within the video component or one or more no-data manipulations within the audio component and within the video component.
   For instance, there can be thresholds for audio components and thresholds for video components. Thus, a threshold comparison can be made to determine whether an amplified amplitude/phase difference for an audio component is greater than an audio threshold, another threshold comparison can be made to determine whether an amplified amplitude/phase difference for a video component is greater than a video threshold, etc.

It is understood that the classification can be extended further to classify one or more data manipulations within one or more audio components or one or more no-data manipulations within one or more audio components, one or more data manipulations within one or more video components or one or more no-data manipulations within one or more video components, one or more data manipulations within one or more audio components and within one or more video components or one or more no-data manipulations within one or more audio components and within one or more video components, etc.

The instructions can cause the processing module 104 to generate an output representative of the classification. The output can be presented to a user via a user interface. For instance, the system 100 can be in communication with a computer device or be part of a computer device. The computer device can include a display configured to generate a user interface. The user interface can include actuatable elements to allow a user to control aspects of the system 100—e.g., select data inputs for processing, select frequency bands, select thresholds, etc. The user interface can also display the output representative of the classification of the data input. This can be a textual output, an audible output, a graphical output (e.g., an intensity plot, a phase plot, etc.), etc. The user interface can reconstruct the audio-video data stream or the audio-video data file and identify (e.g., tag) it with the classification, can reconstruct the audio-video data stream or the audio-video data file with the magnification for presentation to the user, etc.

An exemplary embodiment can relate to a method for detecting an anomaly in an audio-video data stream or an audio-video data file. The method can involve receiving data input including an audio-video data stream or an audio-video data file. The method can involve extracting an audio feature and a corresponding video feature within a frequency band, the frequency band spanning a spatial and temporal range between at least two video frames of the data input, the extraction being based on a machine learning technique that extracts features based on patterns. The method can involve generating an audio vector associated with the extracted audio feature. The method can involve generating a video vector associated with the extracted video feature. The method can involve amplifying via a non-Lagrangian technique: amplitude differences of spatial and temporal values between the at least two video frames; and/or phase differences of spatial and temporal values between the at least two video frames. The method can involve performing a threshold comparison by determining whether an amplified amplitude difference is greater than a threshold amplitude difference and/or whether an amplified phase difference is greater than a threshold phase difference. The method can involve determining, based on the threshold comparison, change-in-position of an object associated with the extracted audio feature and corresponding video feature as a change-in-position anomaly or a change-in-position normality. The method can involve classifying the data input as including a data manipulation or a no-data manipulation based on the change-in-position anomaly or the change-in-position normality. The method can involve generating an output representative of the classification.

The data input can include an audio component and a video component, and the method can involve classifying the data input as including: one or more data manipulations within the audio component or one or more no-data manipulations within the audio component; one or more data manipulations within the video component or one or more no-data manipulations within the video component; or one or more data manipulations within the audio component and within the video component or one or more no-data manipulations within the audio component and within the video component.

The data input can include plural audio components and plural video components, and the method can involve classifying the data input as including: one or more data manipulations within one or more audio components or one or more no-data manipulations within one or more audio components; one or more data manipulations within one or more video components or one or more no-data manipulations within one or more video components; or one or more data manipulations within one or more audio components and within one or more video components or one or more no-data manipulations within one or more audio components and within one or more video components.

An amplitude difference of spatial and temporal values between at least two video frames can include determining a difference of intensities of two pixels corresponding with each other over a period of time. A phase difference of spatial and temporal values between at least two video frames can include determining a difference of phase of two pixels corresponding with each other over a period of time.

Determining a difference of intensities of two pixels corresponding with each other over a period of time can include determining a variation of an intensity of a pixel in a first video frame with an intensity of a corresponding pixel in a second video frame. Determining a difference of phase of two pixels corresponding with each other over a period of time can include determining a variation of phase of a Fourier Transform of an intensity signal of a pixel in a first video frame with a Fourier Transform of an intensity signal of a corresponding pixel in a second video frame. Determining a variation of phase can include determining a degree with which the Fourier Transforms of intensity signals are in-phase or out-of-phase.

The threshold amplitude difference can be based on an expected amplitude difference associated with Lagrangian amplification of the spatial and temporal values. The threshold phase difference can be based on an expected phase difference associated with Lagrangian amplification of the spatial and temporal values.

The non-Lagrangian amplification technique can include a Eulerian magnification technique.

The change-in-position of object can include: object placement or position in a first video frame relative to the object's placement or position in a second video frame; distance between two objects in a first video frame relative to distance between the two objects in a second frame; and/or be based on differences in human physiological watermarks captured via one or more computer vision techniques.

The human physiological watermarks captured via one or more computer vision techniques can involve an Eulerian magnification technique that magnifies color changes of human skin over plural video frames, and the method can involve augmenting the extracted audio feature and the extracted video feature with the magnified color changes of human skin.

### EXAMPLES

The following are exemplary systems, methods, and implementations of the embodiments disclosed herein. While the examples may focus on one implementation, it is understood that this is exemplary and the embodiments disclosed herein are not limited thereto.

Ablation studies demonstrate that motion vectors based on parameters such as number of frames, sample interval, window size, width, height, etc., as well as physiological inputs (e.g., heartbeat, blood flow, etc.) can facilitate use of human movement as a watermark and thereby provide a means to achieve high video source detection accuracy. For instance, combination vectors representing shape and texture representations from deep motion magnification and phase motion magnification vectors can be used to detect manipulations in video, image, and/or audio—e.g., can detect a deep fake. As explained herein, phase-based magnification techniques applied to these combination vectors can be used to detect what otherwise would be imperceptible changes by evaluating local motions in spatial sub-bands of an image. Phase can be defined as the position of the waveform at any point in time. Relationships with other wave forms (e.g. in-phase or out of phase) can be used to characterize phases.

The amount of magnification can be a very significant parameter when it comes to motion magnification. While over-magnification (setting m=10×) can lose the generative signal, keeping the magnification small (setting m=2×) and using a 5-frame window for a phase model can enhance the ability to detect deep fakes.

For instance, embodiments can provide for a system for multi-model detection of an anomaly in an audio-video data stream containing audio content and video content. The system can include an input for receiving an audio-video data stream. The system can include a memory configured for storing the audio-video data stream as it is received, with an audio component being stored independently of a video component. The system can include a processor for separately processing the audio component and the video component, the processor being configured with a computer program which, when executed will cause the processor to perform the following operations:
1. Extract an audio component waveform vector and a video component frame vector from the audio-video data stream. Extracting the video component frame vector can involve extracting from plural frames of normalized video data.
2. Detect an audio feature using the audio component waveform vector and a first learning algorithm, and detect a video feature using the video frame vector and a second learning algorithm.
3. Amplify the video feature within a specific frequency band using spatial pixel and temporal characteristics of the audio-video data stream to reveal motion representing a defined anomaly. The amplification technique can involve amplifying the video feature with an Eularian magnification model that provides spatial processing of video pixels and temporal processing to identify lower-amplified motion relative to a rate of change of other motion in the audio-video data stream. A series of temporal filters can be used to perform temporal processing of the video component frame vector to facilitate outputting a video tensor representing amplified motion. The audio component waveform vector and the video component frame vector can be formatted with a motion vector as a data tuple. The data tuple can then be supplied to a learning model which includes the first learning algorithm for deep learning processing of the audio component waveform vector, and the second learning algorithm for processing the video component waveform vector to detect the video feature, for output of the audio feature and the video feature with the motion vector. Processing the data tuple can involve processing the audio component waveform vector, the video component frame vector (using a fast Fourier transform technique), and the motion vector with a 3-layer multi-layer perceptron (MCP) model trained using cross-entropy loss against four classes, which can facilitate classifying the audio-video data stream as including either an audio anomaly, or a video anomaly, or both.
4. Classify the audio-video data stream as containing an anomaly within the audio content and/or the video content.

FIG. 1B shows an exemplary implementation of an embodiment of the techniques disclosed herein. The exemplary implementation of FIG. 1B may be referred to as DeeperFusionAVM. DeeperFusionAVM takes a video input and extracts the audio to save it as a tensor. It then extracts the frames from the video, which are also saved as a tensor. From there, a copy of the video tensor is made which is then augmented by a human watermark detection process. In this specific exemplary implementation, the watermarking process is done via Eulerian Video Magnification (EVM), which magnifies color changes over the time dimension (frames) of the video. A copy of the EVM tensor is then appended to the end of the video tensor. At this stage, there are three tensors: the separated audio, the original video frames with the EVM frames appended at the end, and the EVM frames by themselves. Both the audio and video/EVM tensors are passed through their respective modules of the DeeprFusionAVM model, and a fast Fourier transform is performed on the EVM-only tensor. This converts the signal in the EVM-only video to a frequency domain. The result is generation of an audio output tensor, a video output tensor, and an EVM output tensor, which are combined into one large tensor to be passed through the final layers of the model. This combined tensor is operating in the latent space (middle layers) of the model, meaning the values in the tensor itself are not meaningful to humans. This is worth noting because only the final block in the model (the fully connected layers) interprets all of the information present in the latent tensor to finally classify the initial video file as one of: a) real-video, real-audio; b) real-video, fake-audio; c) fake-video, real-audio; d) fake-video, fake-audio. It is important to note that in this specific exemplary implementation, EVM is used as the human watermark detection method, but other methods can be used (e.g. pupil shapes, corneal reflection, etc.).

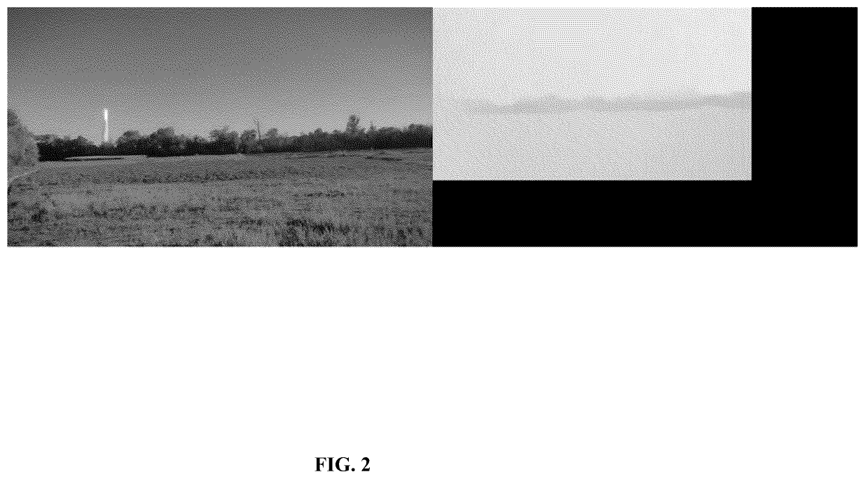

FIG. 2 shows an optical flow technique that predicts a motion vector for every pixel across consecutive frames of a video. This is an exemplary Lagrangian technique. The flow indicates the displacement of video every single pixel in the first image and maps it to its corresponding pixel in the second image.

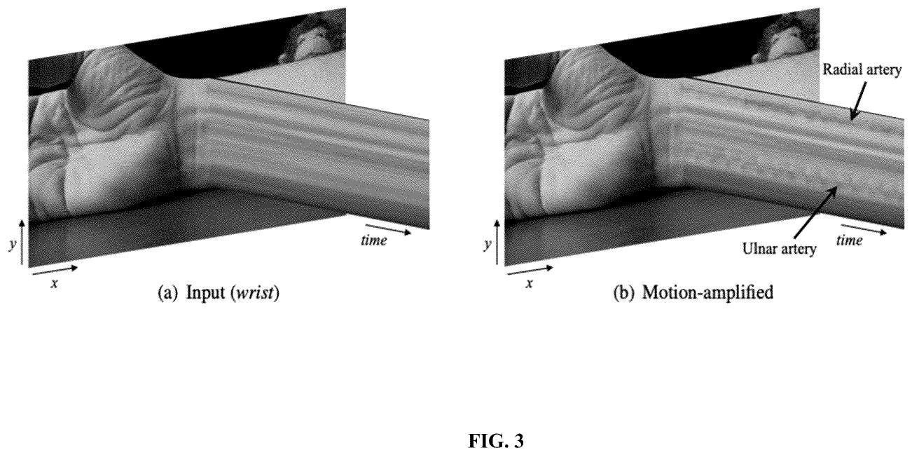

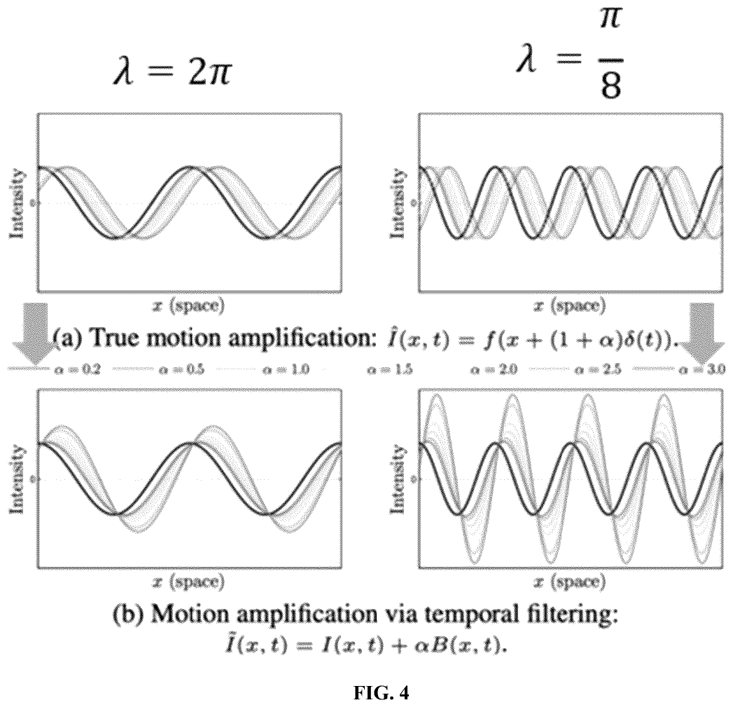

FIG. 3 shows an Eulerian Video Magnification (“EVM”) technique. This is an exemplary non-Lagrangian technique that can use spatial (pixel) and temporal processing to amplify variation given a frequency band of interest to reveal low-amplitude motion. As this technique is a non-Lagrangian method, it does not track motion like Lagrangian methods do. Thus, this technique can amplify very small motions despite not tracking motion. With an Eulerian approach, variation of pixel values (as opposed to fluid) can be amplified over time in a spatially-multiscale manner—e.g., it does not estimate motion, but rather exaggerates it. For example, assume frequencies 0.4-4 Hz˜24-240 bpm (pulse) are selected as the frequency band of interest. A narrow band can be applied around these values. Extracted band-passed signal(s) can be multiplied by a magnification factor of alpha (modifiable parameter). The magnified signal(s) can be added to the original signal, wherein the spatial pyramid can be collapsed to obtain an output. FIG. 4 shows graphical illustrations of motion amplification on a 1D signal for different spatial frequencies and a values.

The forementioned steps are mathematically represented below:
1. Image intensity I as position x,t can be represented as:

$$I ( x , t ) = f ( x + δ \hat{(} t ) )$$

2. With a first-order Taylor series expansion, the image at time t can be rewritten as:

$$I ( x , t ) \approx f ( x ) + δ ( t ) \frac{\partial f ( x )}{\partial x} .$$

3. The result of applying a broadband temporal bandpass filter to I(x,t) at every position x can be expressed as:

$$B ( x , t ) + δ ( t ) \frac{\partial f ( x )}{\partial x} .$$

4. Amplifying the bandpass signal by α and adding it back to I(x,t) can be expressed as:

$$\tilde{I} ( x , t ) = I ( x , t ) + α B ( x , t ) .$$

5. Adding it back to original the signal to obtain EVM output can be expressed as:

$$\hat{I} ( x , t ) = f ( x + ( 1 + α ) δ ( t ) )$$

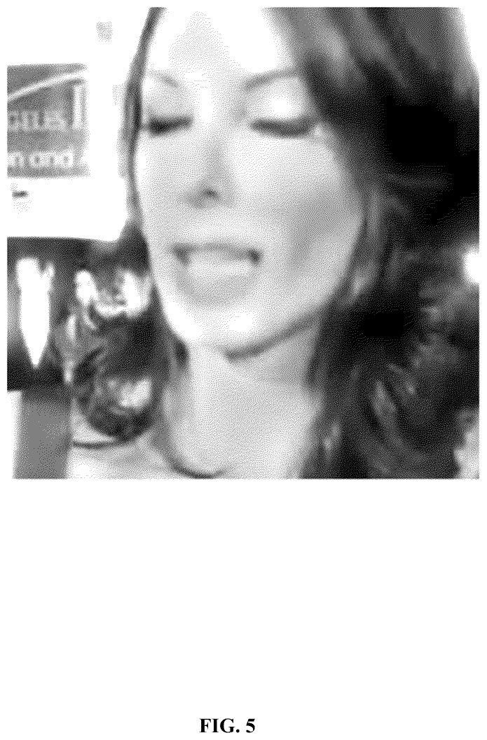

FIG. 5 shows a deep fake video for reference. This is a deep fake video because there are only static vectors, and no amplification—i.e., there are no pulses generated for this frequency band over two or more frames.

FG. 6 illustrates magnification of a crane imperceptibly swaying in the wind. The leftmost image of the original sequence shows a crane. Image (a) shows a zoomed-in portion of a blocked image patch from the leftmost image, image (b) shows results of a linear method for deep fake detection, and image (c) shows results of a phase-based method for deep fake detection. In image (b), the known linear method visualizes the crane's motion, but amplifies both signal and noise and introduces artifacts for higher spatial frequencies and larger motions as shown by the clip intensities (bright pixels). In comparison, image (c) shows that a phase-based method supports larger magnification factors with significantly fewer artifacts and less noise.

Embodiments disclosed herein can fuse EVM features with audio and video to develop a multimodal deep fake detection (DFD) model (e.g., the DeeperFusionAVM). Using EVM alone can be computationally efficient. However, EVM depends on amplitude, which means that errors can be amplified with variation in the wavelength—e.g., EVM can be sensitive to noise. Unlike EVM, phase-based magnification can remove dependence on amplitude, wherein a complex-shift using the phase (as opposed to amplitude) of the signals can be exploited. This phase-based technique can work on high-speed FMV (500 Hz) (band-pass filter of 30-50 Hz) and low amplitude (10-400 micron) movements like eye saccade movements. Employing this technique can result in less error even with very large shifts in magnitude.

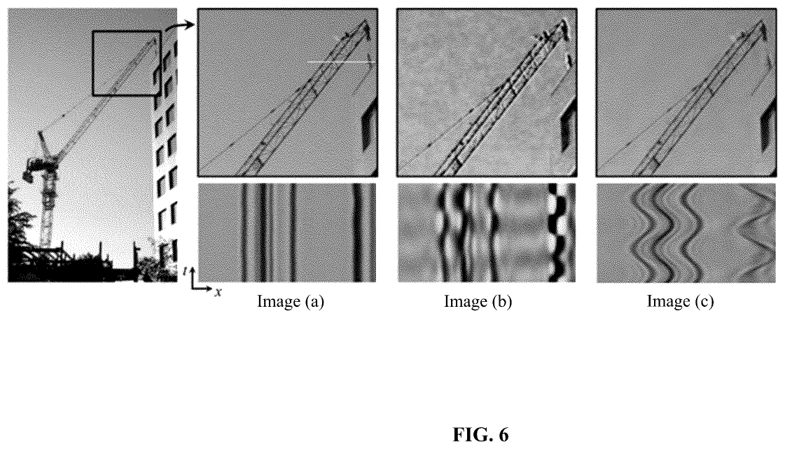

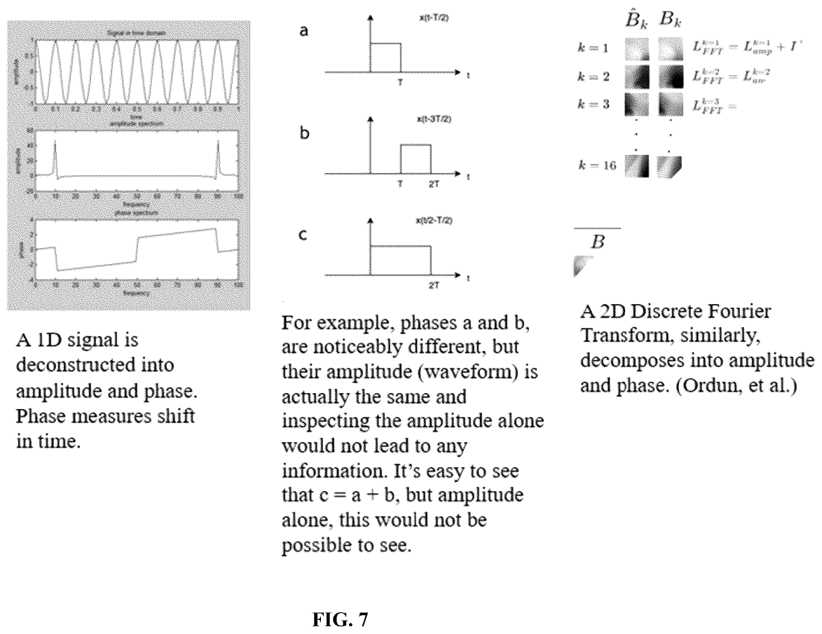

An exemplary phase-based video motion processing technique using a non-Lagrangian technique is shows in image (c) of FIG. 6. FIG. 7 shows a 1D signal being deconstructed into amplitude and phase, and also shows a 2D Discrete Fourier Transform similarly decomposed into amplitude and phase. This exemplary phase-based video motion processing technique is mathematically represented below:
1. Using a Fourier series decomposition, the displaced image profile f, can be expressed as a sum of complex sinusoids:
2. The band for frequency ω is the complex sinusoid:
3. Motion in specific temporal frequencies can be isolated by temporally filtering the phase, which can be expressed as:

$${B}_{ω} ( x , t ) = ω δ ( t ) .$$

4. The resulting signal is a complex sinusoid that has motions exactly 1+α times the input:

$${\hat{S}}_{ω} ( x , t ) := {S}_{ω} ( x , t ) {e}^{i α {B}_{ω}} = {A}_{ω} {e}^{i ω ( x + ( 1 + α ) δ ( t ) )} .$$

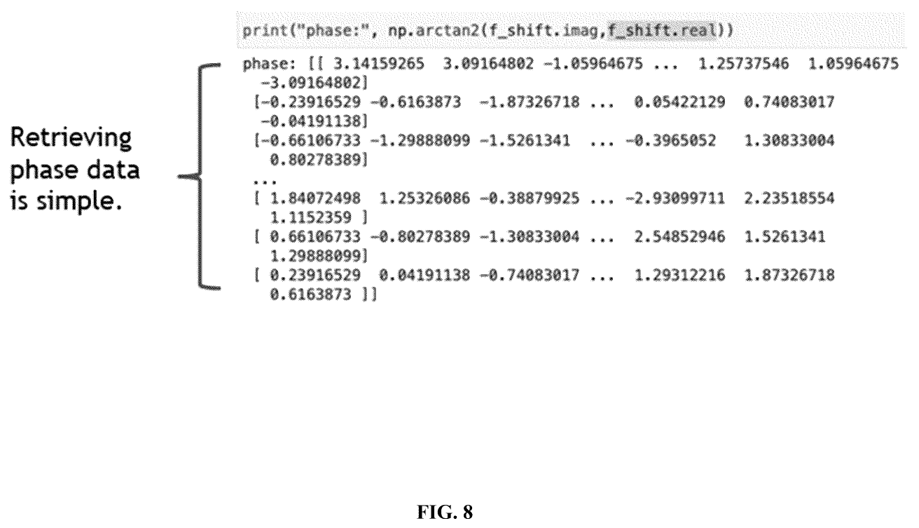

FIG. 8 shows an example of retrieving phase data. As can be appreciated simple processing can be used to retrieve phase data.

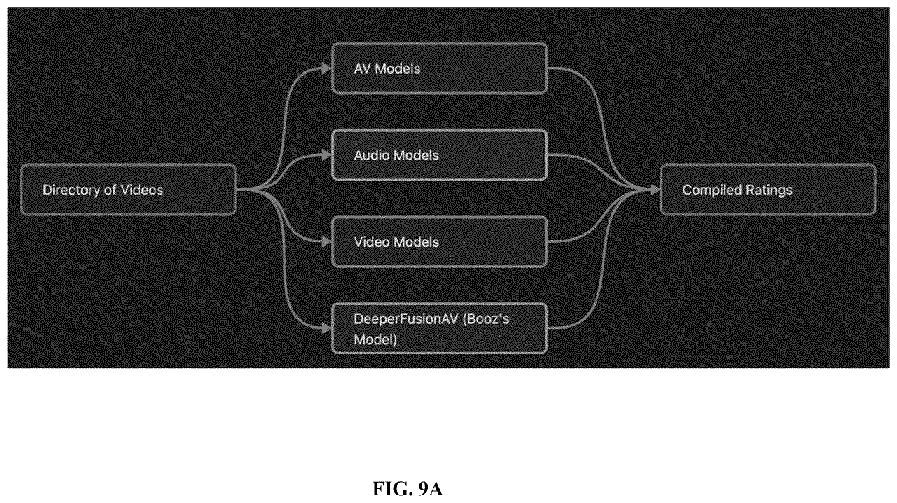

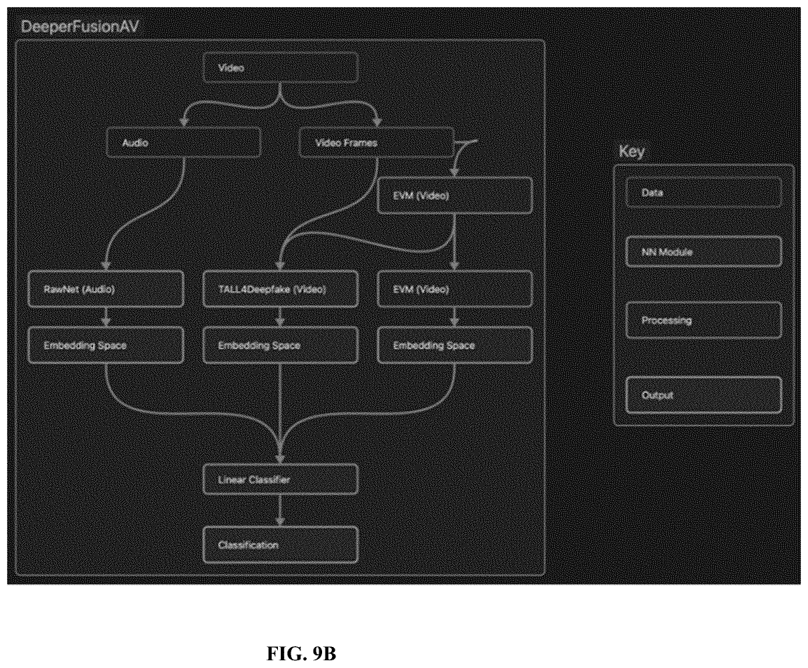

FIGS. 9A-9B show exemplary flow diagrams for implementing an embodiment of the multi-modal deep fake detection system. As can be appreciated, a video processing model can be trained on a large AV deep fake detection dataset. A video data stream can be inputted into a preprocessing module that extracts audio as a waveform vector. The video can be extracted into frames, which can then be normalized. A tuple of audio and video vectors can be generated, wherein the video frames can be outputted to the tuple. The video frames can also be sent in parallel to an EVM video module processor where motion vectors can be processed by a 2D Fourier Transform (FFT) into vectors. The EVM video module can be configured in open source code (e.g., PyEVM code) that can apply a standard process of Gaussian pyramids across frames, apply a series of temporal filters (also Fourier-1D-transform), amplify them, and output a video tensor that represents amplified motion across the video batch.

The combination of audio, video (frames), and the EVM 2D FFT vectors can be passed to a multi-model. The audio can be sent to a first learning algorithm, (e.g., a RAWNET) that can be a series of convolutio nal layers with attention for deep learning detection. The video can be sent to a second learning algorithm (e.g., a SwinTransformer). The outputs of each learning algorithm are learned features that can then be fused together along with the FFT from the EVM video module. Note that the EVM may not be passed to a third deep learning model, but rather can be directly sent into an embedding space of the output of multi-model in parallel with audio and video features.

A third algorithm can be a 3-layer multi-layer perceptron (MLP) algorithm that can take the concatenated vectors as a tuple (audio, video, motion) and train a classifier using Cross Entropy Loss against classes (e. g., four classes) for identifying which of four classes includes an anomaly: i.e., any of an audio and/or video fake: 1) audio yes, video no; 2) audio no, video yes; 3) audio no, video no; 4) audio yes, video yes. The output can be provided to a user interface. The output can be provided to a user interface.

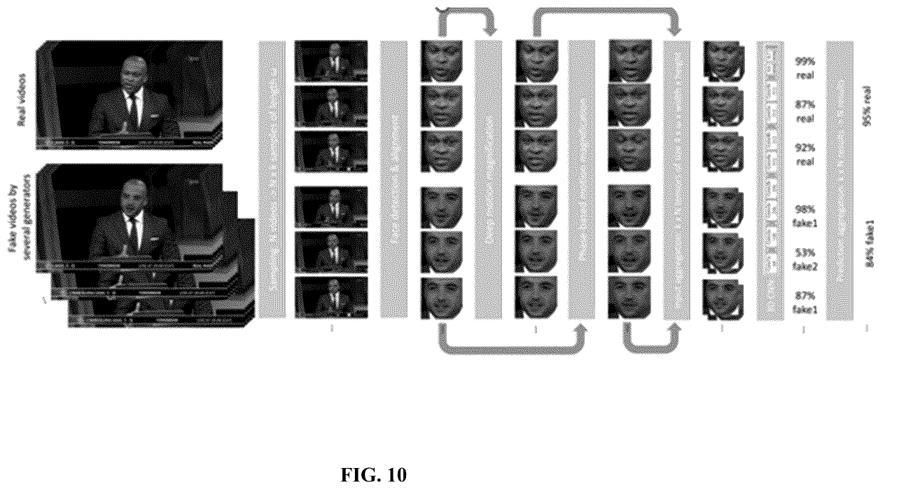

FIG. 10 illustrates known real and fake videos from several generators, wherein a solution selects fixed-window samples, extracts and aligns faces, applies deep and phase-based motion magnification to aligned faces, combines magnified outputs, trains a 3D Conserved Domain Database (CDD), and aggregates predictions into video predictions to classify the video as real or generated.

The system can be a multi-modal and multi-model approach for detecting deep fake audio/video (AV) videos. This approach can leverage multiple models that consume a multitude of modalities (e.g., audio, visual, as well as models that analyze audio and video together). Several models can be integrated into one pipeline which can include AV models, audio models, video models, and an AV-Eulerian Magnification models implemented as a video processing AV model. The AV models can include a combination of known models, such as Lagrangian models, non-Lagrangian models, etc. The AV-Eulerian Video Magnification video processing model can be used in conjunction with a combination of known models to provide a parallel pipeline architecture. The Eulerian Video Magnification (e.g., non-Lagrangian) can provide spatial (pixel) and temporal processing to amplify variation given a frequency band of interest to reveal low-amplitude motion. As can be appreciated, very small motion (relative to larger scale motion of frame-to-frame analysis) can be amplified despite not tracking frame-to-frame motion (e.g., Lagrangian methods to provide phase based video motion processing) to, for example, provide a phased-based output. Any one or more models can be combined with processing techniques disclosed herein to achieve highly precise results with high confidence. Exemplary models can include: an AASIST model, an AVForensics model, a Deep fake Supcon model, an Exposing the Deception model, a FakeOut model, a TALL4Deep fake model, etc.

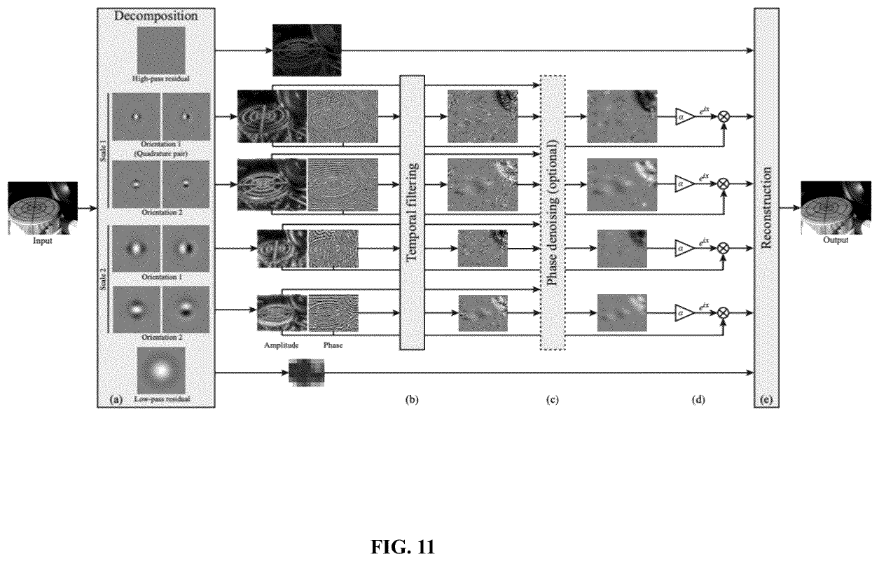

FIG. 11 shows an exemplary architecture for implementing an embodiment of the system and method. A video component is received at an input. In block (a), the signals of local phase can be analyzed over time in different spatial scales and orientations by using complex steerable pyramids to decompose the video in a decomposition module and separate the amplitude of the local wavelets from their phase. In block (b), temporal filtering of the phases can then be performed independently at each location, orientation, and/or scale. Optionally, in block (c), an amplitude-weighted spatial smoothing can be applied to increase the phase signal-to-noise (SNR) and improve the result. In block (d), the process can amplify or attenuate the temporally-bandpassed phases. In block (e), the video can be reconstructed for output at a user interface (e.g., graphical user interface).

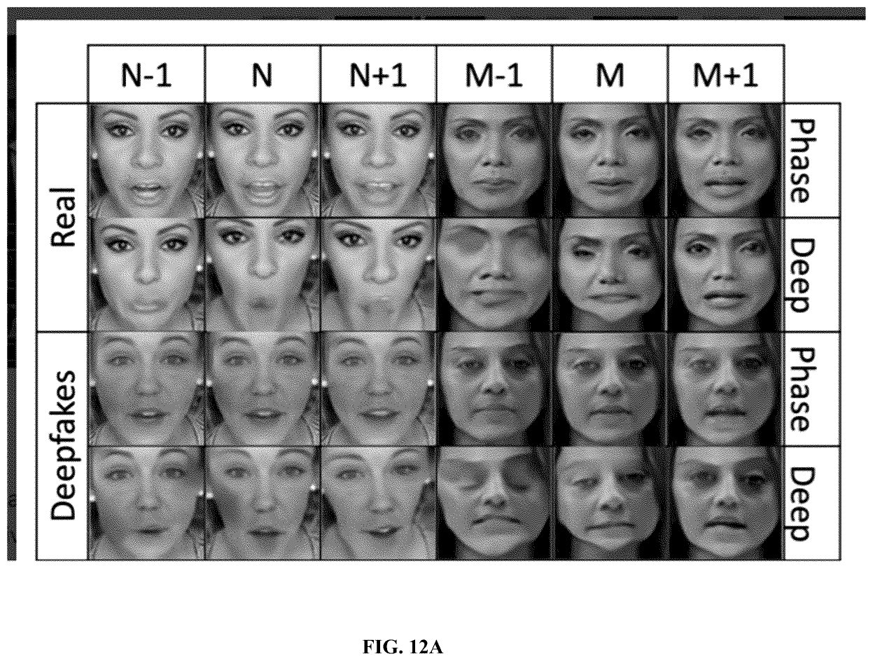

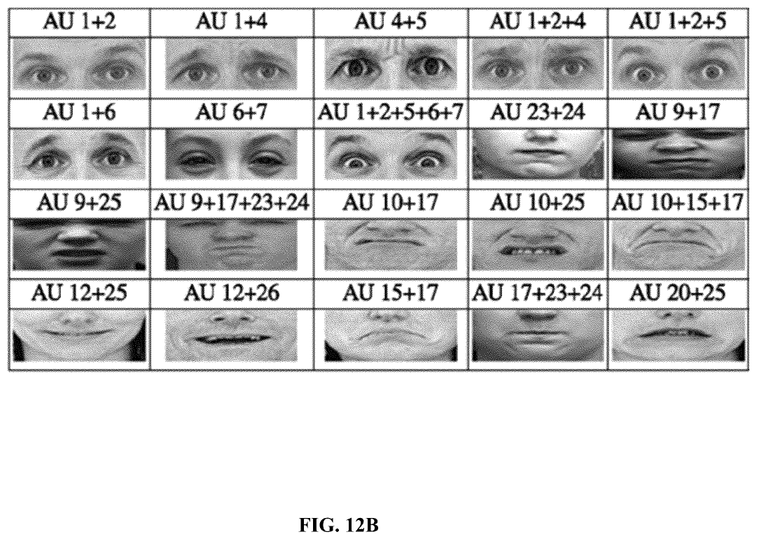

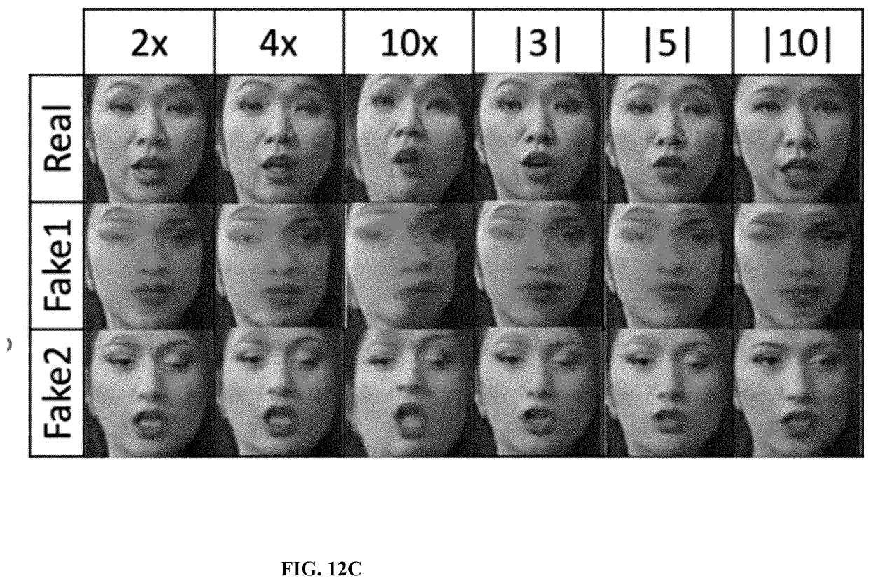

FIGS. 12A-12C illustrate known experiments on different magnification parameters, and depicts effects of deep motion magnification amount m (left three columns) and phase-based magnification interval t (right three columns).

It will be understood that modifications to the embodiments disclosed herein can be made to meet a particular set of design criteria. For instance, any of the components, features, or steps of the system, apparatus, or method can be any suitable number or type of each to meet a particular objective. Therefore, while certain exemplary embodiments of the systems and methods disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

What is claimed is:

1. A system for detecting an anomaly in an audio-video data stream or an audio-video data file, the system comprising:
an input module configured to receive data input including an audio-video data stream or an audio-video data file;
a processing module;
a memory having instructions thereon that, when executed by the processing module, will cause the processing module to:
extract an audio feature and a corresponding video feature within a frequency band, the frequency band spanning a spatial and temporal range between at least two video frames of the data input, the extraction being based on a machine learning technique that extracts features based on patterns;
generate an audio vector associated with the extracted audio feature;
generate a video vector associated with the extracted video feature;
amplify, via a non-Lagrangian technique:
amplitude differences of spatial and temporal values between the at least two video frames; and/or
phase differences of spatial and temporal values between the at least two video frames;
perform a threshold comparison by determining whether an amplified amplitude difference is greater than a threshold amplitude difference and/or whether an amplified phase difference is greater than a threshold phase difference;
determine, based on the threshold comparison, change-in-position of an object associated with the extracted audio feature and corresponding video feature as a change-in-position anomaly or a change-in-position normality;
classify the data input as including a data manipulation or a no-data manipulation based on the change-in-position anomaly or the change-in-position normality; and
generate an output representative of the classification.

2. The system of claim 1, wherein the data input includes an audio component and a video component, and the instructions will cause the processing module to:
classify the data input as including:
one or more data manipulations within the audio component or one or more no-data manipulations within the audio component;
one or more data manipulations within the video component or one or more no-data manipulations within the video component; or
one or more data manipulations within the audio component and within the video component or one or more no-data manipulations within the audio component and within the video component.

3. The system of claim 1, wherein the data input includes plural audio components and plural video components, and the instructions will cause the processing module to:
classify the data input as including:
one or more data manipulations within one or more audio components or one or more no-data manipulations within one or more audio components;
one or more data manipulations within one or more video components or one or more no-data manipulations within one or more video components; or
one or more data manipulations within one or more audio components and within one or more video components or one or more no-data manipulations within one or more audio components and within one or more video components.

4. The system of claim 1, wherein:
an amplitude difference of spatial and temporal values between the at least two video frames includes determining a difference of intensities of two pixels corresponding with each other over a period of time; and/or
a phase difference of spatial and temporal values between the at least two video frames includes determining a difference of phase of two pixels corresponding with each other over a period of time.

5. The system of claim 4, wherein:
determining a difference of intensities of two pixels corresponding with each other over a period of time includes determining a variation of an intensity of a pixel in a first video frame with an intensity of a corresponding pixel in a second video frame; and/or
determining a difference of phase of two pixels corresponding with each other over a period of time includes determining a variation of phase of a Fourier Transform of an intensity signal of a pixel in a first video frame with a Fourier Transform of an intensity signal of a corresponding pixel in a second video frame.

6. The system of claim 5, wherein:
determining a variation of phase includes determining a degree with which the Fourier Transforms of intensity signals are in-phase or out-of-phase.

7. The system of claim 1, wherein:
the threshold amplitude difference is based on an expected amplitude difference associated with Lagrangian amplification of the spatial and temporal values; and/or
the threshold phase difference is based on an expected phase difference associated with Lagrangian amplification of the spatial and temporal values.

8. The system of claim 1, wherein:
the non-Lagrangian amplification technique includes a Eulerian magnification technique.

9. The system of claim 1, wherein:
the change-in-position of object includes:
object placement or position in a first video frame relative to the object's placement or position in a second video frame;
distance between two objects in a first video frame relative to distance between the two objects in a second frame; and/or
differences in human physiological watermarks captured via one or more computer vision techniques.

10. The system of claim 9, wherein:
the human physiological watermarks captured via the one or more computer vision techniques involves an Eulerian magnification technique that magnifies color changes of human skin over plural video frames; and
the instructions will cause the processing module to augment the extracted audio feature and the extracted video feature with the magnified color changes of human skin.

11. A method for detecting an anomaly in an audio-video data stream or an audio-video data file, the method comprising:
receiving data input including an audio-video data stream or an audio-video data file;
extracting an audio feature and a corresponding video feature within a frequency band, the frequency band spanning a spatial and temporal range between at least two video frames of the data input, the extraction being based on a machine learning technique that extracts features based on patterns;
generating an audio vector associated with the extracted audio feature;
generating a video vector associated with the extracted video feature;
amplifying via a non-Lagrangian technique:
amplitude differences of spatial and temporal values between the at least two video frames; and/or
phase differences of spatial and temporal values between the at least two video frames;
performing a threshold comparison by determining whether an amplified amplitude difference is greater than a threshold amplitude difference and/or whether an amplified phase difference that is greater than a threshold phase difference;
determining, based on the threshold comparison, change-in-position of an object associated with the extracted audio feature and corresponding video feature as a change-in-position anomaly or a change-in-position normality;
classifying the data input as including a data manipulation or a no-data manipulation based on the change-in-position anomaly or the change-in-position normality; and
generating an output representative of the classification.

12. The method of claim 11, wherein the data input includes an audio component and a video component, and the method comprises classifying the data input as including:
one or more data manipulations within the audio component or one or more no-data manipulations within the audio component;
one or more data manipulations within the video component or one or more no-data manipulations within the video component; or
one or more data manipulations within the audio component and within the video component or one or more no-data manipulations within the audio component and within the video component.

13. The method of claim 11, wherein the data input includes plural audio components and plural video components, and the method comprises classifying the data input as including:
one or more data manipulations within one or more audio components or one or more no-data manipulations within one or more audio components;
one or more data manipulations within one or more video components or one or more no-data manipulations within one or more video components; or
one or more data manipulations within one or more audio components and within one or more video components or one or more no-data manipulations within one or more audio components and within one or more video components.

14. The method of claim 11, wherein:
an amplitude difference of spatial and temporal values between the at least two video frames includes determining a difference of intensities of two pixels corresponding with each other over a period of time; and/or
a phase difference of spatial and temporal values between the at least two video frames includes determining a difference of phase of two pixels corresponding with each other over a period of time.

15. The method of claim 14, wherein:
determining a difference of intensities of two pixels corresponding with each other over a period of time includes determining a variation of an intensity of a pixel in a first video frame with an intensity of a corresponding pixel in a second video frame; and/or
determining a difference of phase of two pixels corresponding with each other over a period of time includes determining a variation of phase of a Fourier Transform of an intensity signal of a pixel in a first video frame with a Fourier Transform of an intensity signal of a corresponding pixel in a second video frame.

16. The method of claim 15, wherein:
determining a variation of phase includes determining a degree with which the Fourier Transforms of intensity signals are in-phase or out-of-phase.

17. The method of claim 11, wherein:
the threshold amplitude difference is based on an expected amplitude difference associated with Lagrangian amplification of the spatial and temporal values; and/or
the threshold phase difference is based on an expected phase difference associated with Lagrangian amplification of the spatial and temporal values.

18. The method of claim 11, wherein:
the non-Lagrangian amplification technique includes a Eulerian magnification technique.

19. The method of claim 11, wherein:
the change-in-position of object includes:
object placement or position in a first video frame relative to the object's placement or position in a second video frame;
distance between two objects in a first video frame relative to distance between the two objects in a second frame; and/or
differences in human physiological watermarks captured via one or more computer vision techniques.

20. The method of claim 19, wherein the human physiological watermarks captured via the one or more computer vision techniques involves an Eulerian magnification technique that magnifies color changes of human skin over plural video frames, and the method comprises:
augmenting the extracted audio feature and the extracted video feature with the magnified color changes of human skin.
